(19) United States
(12) Patent Application Publication
(10) Pub. No.: US 2003/0113049 A1
(43) Pub. Date: Jun. 19, 2003

(54) Laying head bearing with offset preloading

(76) Inventors: T. Michael Shore, Princeton, MA (US); James F. Walsh, Shrewsbury, MA (US)

Correspondence Address: Attn: Maurice E. Gauthier, Samuels, Gauthier & Stevens, LLP, 225 Franklin Street, Suite 3300, Boston, MA, 02110, US

(21) Appl. No.: 10/082,986

(22) Filed: Feb. 26, 2002

Related U.S. Application Data
(60) Provisional application No. 60/340,190, filed on Dec. 14, 2001.

(51) Int. Cl. F16C 19/24

(52) U.S. Cl. 384/548

(57) ABSTRACT

A bearing assembly is disclosed for rotatably supporting a quill in the housing of a rolling mill laying head. The bearing assembly comprises first and second axially spaced roller bearing sets interposed between the quill and the housing. A radial preloading force is applied to the first bearing set at a first location around its circumference. The preloading force is opposed by a reactionary force acting on the second bearing set at a second location around its circumference disposed 180° from the first location.

### CROSS REFERENCETO RELATED APPLICATION

This application claims priority from U.S. Provisional Patent Application Serial No. 60/340,190 filed Dec. 14, 2001.

### BACKGROUND OF THE INVENTION

1. Field of the Invention

This invention relates to laying heads of the type employed in high speed rod mills to form the hot rolled exiting product into a helical formation of rings.

2. Description of the Prior Art

A conventional laying head is schematically depicted at 10 in FIG. 1. The laying head includes a housing 12 containing a hollow quill 14 rotatably supported between front and rear roller bearing assemblies 16 and 18. The quill 14 carries a bevel gear 20 meshing with a mating bevel gear 22, the latter being driven in a conventional manner by a gear box and motor (not shown).

A laying pipe 24 is carried by the quill 14. The laying pipe has an entry end 24a aligned with the rotational axis X of the quill, and a curved intermediate section 24b leading to an exit end 24c spaced radially from the axis X.

In a typical modern day high speed rolling operation, a finished rod with a 5.5 mm diameter exits the mill a speeds on the order of 112-120 m/sec and at a temperature in the range of 750 to 1100° C. The rod can either be delivered to the laying head at these elevated temperatures, or it can be water cooled down to about 600-950° C. before it enters the entry end 24a of the laying pipe. The curvature of the laying pipe, coupled with its rotation about axis X, forms the rod into a helical series of rings R. The rings are delivered to a cooling conveyor (not shown), on which they are distributed in an offset overlapping pattern for additional cooling prior to being gathered into coils.

When operating under these conditions, the laying head can attain rotational speeds on the order of 1500-2250 RPM and higher, and the rotating components of the laying head, including the roller bearing assemblies supporting the quill, can be exposed to temperatures a high as 100-110° C. The roller bearing assemblies must thus be designed with adequate clearances to accommodate thermal expansion and contraction.

It has now been determined that, particularly in the front bearing assembly 16, which is relatively lightly loaded, at certain speeds such clearances can cause detrimental roller skidding and vibration.

### SUMMARY OF THE INVENTION

The objective of the present invention is to eliminate or at least significantly reduce roller skidding and vibration caused by clearances in the front bearing assembly.

To this end, the front bearing assembly is subdivided into first and second axially spaced roller bearing sets. A radial preloading force is applied to the first roller bearing set at a first location around the circumference thereof. The preloading force is opposed by a reactionary force acting on the second bearing set at a second location around its circumference disposed 180° from the first location.

These and other objectives and features of the present invention will now be described in greater detail with reference to the accompanying drawings, wherein:

### BRIEF DESCRIPTION OF THE DRAWINGS

FIG. 1 is a schematic representation of a typical high speed rod laying head;

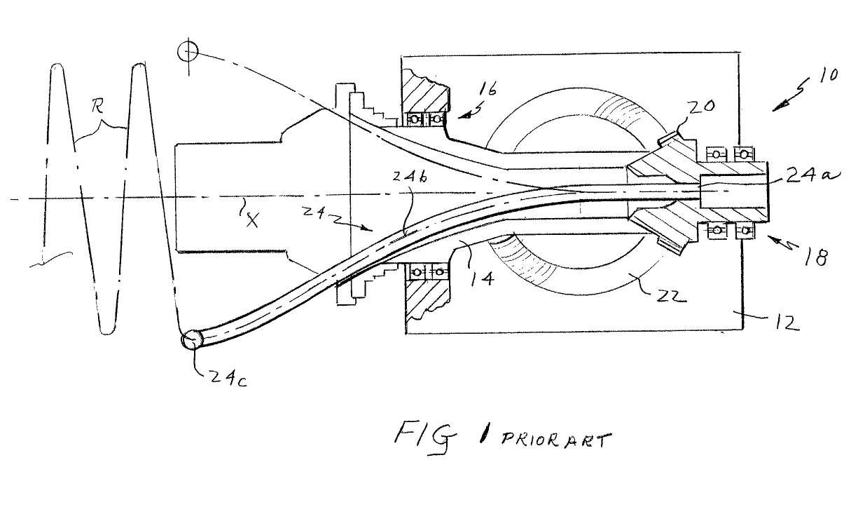

FIG. 2 is an enlarged longitudinal sectional view of the front portion of a laying head with the laying pipe removed, and incorporating a preloaded front bearing assembly in accordance with the present invention; and

FIG. 3 is a sectional view taken along line 3-3 of FIG. 2.

### DETAILED DESCRIPTION OF PREFERRED EMBODIMENT

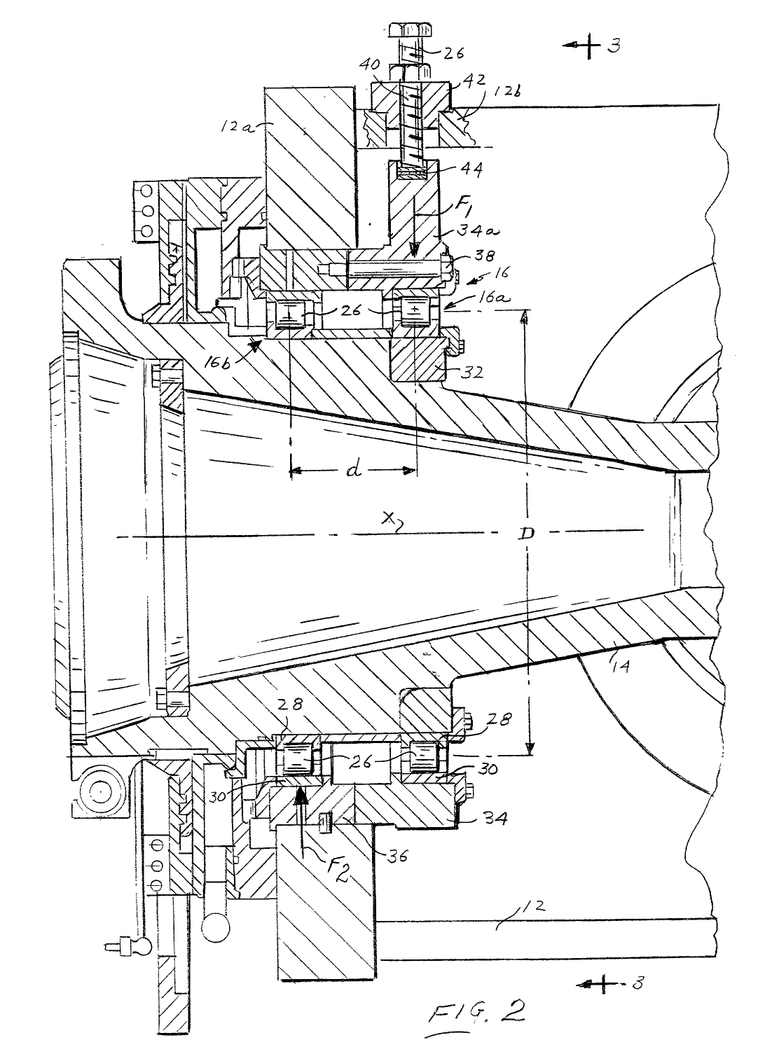

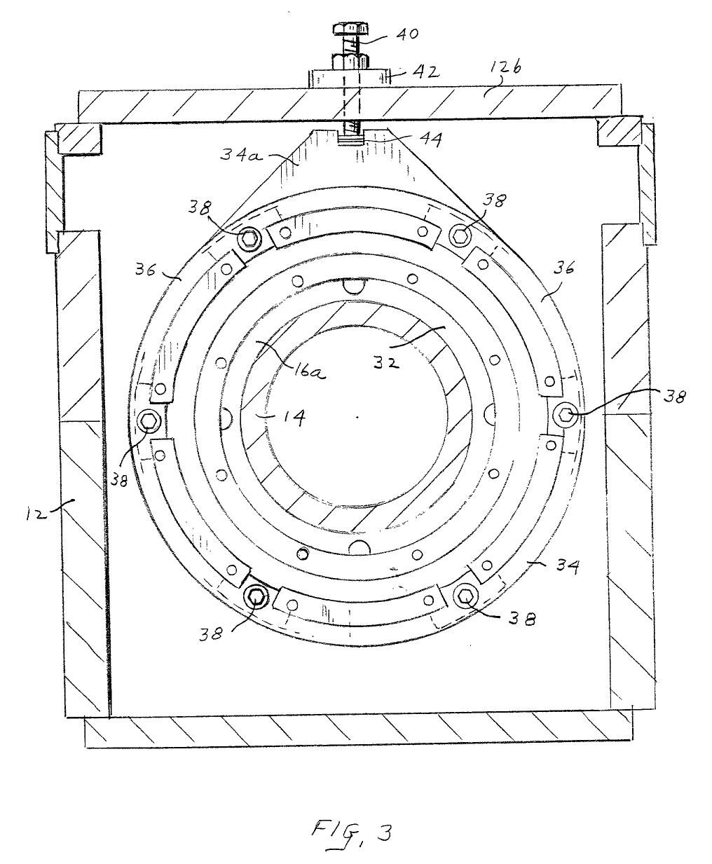

As can be best seen in FIGS. 2 and 3, the front bearing assembly 16 of the present invention includes first and second roller bearing sets 16a, 16b axially separated by a center to center distance “d”. Preferably, the distance d is between about 5 to 40% of the nominal diameter “D” of the bearing sets 16a, 16b.

Each bearing set 16a, 16b includes roller elements 26 captured between circular inner and outer races 28, 30. The inner race 28 of bearing set 16b is seated on and fixed relative to the quill 14. The inner race 28 of bearing set 16a is seated on and fixed relative to an inner ring 32, which in turn is shrunk onto the quill.

The outer races 30 of the first and second bearing sets 16a, 16b are contained respectively, in first and second cartridges 34, 36. The cartridges 34, 36 are retained in an integral axially aligned and abutting relationship by any convenient means, such a for example retainer screws 38.

The second cartridge 36 is received and rotatably fixed in a bore in a front plate 12a of the housing 12. The first cartridge 34 projects axially and inwardly from the second cartridge 36 into the interior of the housing.

The first cartridge 34 includes an integral lobe 34a underlying a top plate 12b of the housing. Lobe 34a is engaged by an adjustable bolt 40 threaded through a bushing 42 on the top plate 12b.

By appropriately adjusting the bolt 40, a downward preloading force F₁ is exerted on the first bearing set 16a at a first location along its circumference. The interposition of a resilient “bellville” washer 44 between the bolt 40 and lobe 34a insures that the preloading force is resiliently applied. The preloading force may also be applied by equivalent alternative means, e.g., pressure cylinders, plastic or gas springs, etc.

The preloading force F₁ on the first bearing set 16a is opposed by a reactionary force F₂ exerted by the front housing plate 12a and acting on the second bearing set 16b at a second location disposed 180° from the point of application of the preloading force. The preloading and reactionary forces F₁, F₂ act in concert to eliminate clearances respectively in the upper half of the first bearing set 16a and the lower half of the second bearing set 16b. This in turn prevents or at least beneficially reduces both roller skidding and vibration attributable to normal operating clearances between the bearing components.

From the foregoing detailed description, it has been shown how the objectives and advantages of the invention may be obtained in a preferred manner. However, modifications and equivalents of the disclosed concepts such as readily occur to those skilled in the art are intended to be included within the scope of this invention. A non-limiting example of one such modification would be the substitution of hydraulically actuated force exerting means in place of the adjustable bolt 40.

We claim:

1. A bearing assembly for rotatably supporting a quill in the housing of a rolling mill laying head, said bearing assembly comprising:
first and second axially spaced roller bearing sets interposed between said quill and said housing; and
force exerting means for applying a radial preloading force to said first bearing set at a first location around the circumference thereof, said preloading force being opposed by a reactionary force acting on said second bearing set at a second location around the circumference thereof disposed 180° from said first location.

2. The bearing assembly of claim 1 wherein said first and second bearing sets each comprise roller elements captured between circular inner and outer races, said inner races being fixed with respect to said quill and said outer races being fixed with respect to said housing.

3. The bearing assembly of claim 2 wherein said force exerting means is supported by said housing and is arranged to act on the outer race of said first bearing set, and wherein said reactionary force is exerted by said housing acting on the outer race of said second bearing set.

4. The bearing assembly of claim 1 further comprising first and second cartridges respectively containing said first and second bearing sets, and means for retaining said cartridges in an integral axially aligned and abutting relationship.

5. The bearing assembly of claim 4 wherein said second cartridge is received and rotatably fixed in a bore in a front plate of said housing, and wherein said first cartridge projects axially from said second cartridge and inwardly into said housing.

6. The bearing assembly of claim 5 wherein said force exerting means is constructed and arranged to engage said first cartridge.

7. The bearing assembly of claim 1 wherein the center to center distance between said first and second bearing sets is between about 5 to 40% of the nominal diameter of said bearing sets.

8. The bearing assembly of claim 1 wherein said preloading force is resiliently applied.

9. A method of reducing clearances between the components of a bearing assembly rotatably supporting a quill in the housing of a rolling mill laying head, said method comprising:
subdividing the bearing assembly into axially spaced roller bearing sets; and
applying a preloading force to one of said bearing sets at a first location around the circumference thereof, and opposing said preloading force with a reactionary force applied to the other of said bearing sets at a second location around the circumference thereof disposed 180° from said first location.
